(19) United States
(12) Patent Application Publication
(10) Pub. No.: US 2013/0023804 A1
(43) Pub. Date: Jan. 24, 2013

(54) SOUND MASSAGE SYSTEM

(71) Applicants: Karin Klabunde, Eindhoven (NL); Okke Ouweltjes, Eindhoven (NL); Ronaldus Maria Aarts, Eindhoven (NL); Ronald Rietman, Eindhoven (NL)

(72) Inventors: Karin Klabunde, Eindhoven (NL); Okke Ouweltjes, Eindhoven (NL); Ronaldus Maria Aarts, Eindhoven (NL); Ronald Rietman, Eindhoven (NL)

(73) Assignee: KONINKLIJKE PHILIPS ELECTRONICS N.V., EINDHOVEN (NL)

(21) Appl. No.: 13/635,970

(22) PCT Filed: Apr. 5, 2011
(86) PCT No.: PCT/IB11/51459

§ 371 Date: Sep. 19, 2012

(30) Foreign Application Priority Data
Apr. 8, 2010 (EP) 10159374.7

(51) Int. Cl. A61H 1/00

(52) U.S. Cl. 601/47

(57) ABSTRACT

A sound massage system (1) comprises a sound device (3) arranged for producing a rotating sound beam, a vibration element (5) arranged for producing vibrations, wherein the vibration frequency is less than 300 Hertz, and a control unit (7) arranged for controlling the sound device (3) and the vibration element (5). The sound massage system provides imitation of the Tibetan signing bowls. The invention also related to a relaxation system comprising the sound massage system.

### FIELD OF THE INVENTION

The invention relates to a sound massage system used for relaxation and therapeutic purposes. The invention further relates to a relaxation system comprising the sound massage system.

### BACKGROUND OF THE INVENTION

As known in the art, Tibetan singing bowls have been traditionally used for ceremonial and meditation purposes. They are also used for sound massage. For this purpose singing bowls of different sizes, in order to produce different sounds, are placed on or close to the body. Singing bowls are handcrafted using alloys of several metals and produce different sounds of different timbre, depending on the alloy composition, their shape, size and weight. The sound is produced either by impacting or rubbing, or both simultaneously by an exciting stick called puja. Sound massage with singing bowls is a sound therapy where singing bowls are placed on the dressed body or close to the body and tapped gently with a felt mallet. The calming harmonizing sounds as well as the gentle vibrations of the singing bowls induce a feeling of well-being and a very effective deep relaxation, a sound-based relaxation.

A drawback of the known Tibetan singing bowls is that there is a limited number of sounds that can be produced, the number corresponding to the number of available singing bowls, which sounds are determined by the size of the available bowls. In practice different people prefer different sounds, meaning that a different set of singing bowls will be preferred by a different person.

Moreover, the Tibetan singing bowls are expensive to produce. Also they cannot be manipulated by a person who is massaged, or at least it is very difficult and to a certain extent disturbing if the person has to hit bowls himself.

### SUMMARY OF THE INVENTION

It is an object of the present invention to provide a system that solves the above stated problem, i.e. a system that can produce practically an unlimited set of Tibetan-bowl-like sounds.

This object is achieved with the sound massage system according to the invention as defined in claim 1. The system comprises a sound device arranged for producing a rotating sound beam, a vibration element arranged for producing vibrations, wherein the vibration frequency is less than 300 Hertz, and a control unit arranged for controlling the sound device and the vibration element. The rotating sound beam produced by the sound device and the vibrations produced by the vibration element mimic the effects of the known Tibetan bowls very closely. A practically unlimited number of different rotation sound beams can be produced by the same sound device controlled by the control unit. That means that the system according to the invention does not have the above problem of the prior art.

Differently from the Tibetan singing bowls, the sound and the vibration produced by the sound massaging system can be controlled independently from each other. The control unit can be programmable so that a user can choose between different programs or even the user can make his own program.

Moreover, the system according to the invention is much cheaper to produce than a set of the Tibetan singing bowls. Also, the system according to the invention can be manipulated, for example by configuring the control unit in advance, by the same person who is massaged, which is not the case for the known Tibetan singing bowls.

An embodiment of the system according to the invention has the feature that the sound device comprises at least one loudspeaker.

An embodiment of the system according to the invention has the feature that the vibration element is an excitation device, an ultra sound vibrator or pancake motor device.

An embodiment of the system according to the invention has the feature that the control unit is a processor device arranged for executing a control program.

An embodiment of the system according to the invention has the feature that the system comprises a biosensor for measuring a bio-parameter of an object, in particular a human or an animal, using the system and wherein the control unit controls the sound device and the vibration element based on the measured bio-parameter. The advantage of this embodiment is that the massage can be actively adapted based on the measured bio-parameter till a person optimal massaging is achieved.

An embodiment of the system according to the invention has the feature that the measured bio-parameter is sent by the biosensor to the control unit wirelessly.

The invention is also related to a relaxation system as claimed in claim 8. The relaxation system comprises the sound massage system as described above in any one of the previous embodiments. Such relaxation system can also comprise several sound massage systems which can be placed at different positions on or close to the object's body and which can be activated according to a certain sequence or pattern.

### BRIEF DESCRIPTION OF THE DRAWINGS

In the following, the invention and further aspects will be described, by way of example, and explained hereinafter, using the following figures:

FIG. 1 schematically shows a sound massage system according to the invention;

FIG. 2 schematically shows a user using the sound massaging system wherein a bio-parameter of the user is measured by a biosensor;

FIG. 3 schematically shows an electric circuit for production of a rotating sound beam;

### DETAILED DESCRIPTION OF THE EMBODIMENTS

In the following description of the preferred embodiments, reference is made to the accompanying drawings which form a part thereof. Specific embodiments, in which the invention may be practiced, are shown in the following description by way of illustration. It is also understood that other embodiments may be utilized and structural changes may be made without departing from the scope of the present invention. It is noted that the same reference signs will be used for indicating the same or similar parts in the several embodiments.

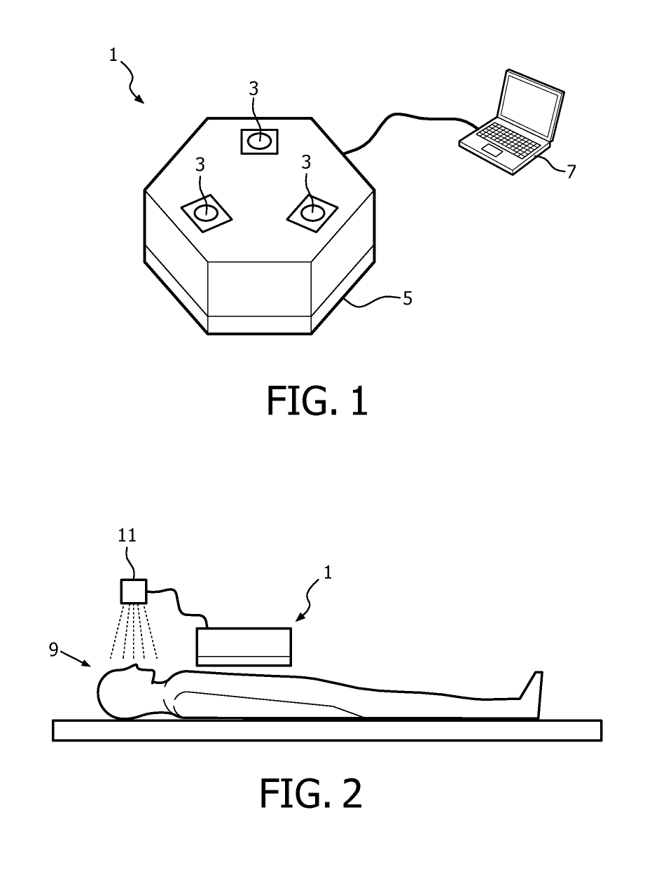

A first embodiment of the invention is shown in FIG. 1. The sound massage system 1 comprises a sound device 3 and a vibration element 5. The sound device 3 and the vibration element 5 are controlled by a control unit 7. Differently from the original Tibetan singing bowls, the sound device 3 and the vibration element 5 can be controlled independently from each other and this provides more flexibility than the original Tibetan singing bowls.

In this concrete example shown in FIG. 1 the sound device comprises three loudspeakers 3. Any other number of loudspeakers is also possible. The loudspeakers are adequately controlled by the control unit 7 so that the loudspeakers produce a rotating sound beam. The rotating sound beam can be also realized as a circular loudspeaker array. The rotation speed can be varied.

The rotating sound beam can be produced also by a single loudspeaker and a mechanical means. In this case the directivity of the loudspeaker is changed by the mechanical means. This can be achieved by the mechanical means comprising a hood and a motor for turning the hood. By turning the hood around the directivity of the loudspeaker is controlled and the rotating sound beam is produced.

Another possibility to use a single loudspeaker is to use a special loudspeaker having plurality of coils. Such loudspeaker can control the cone and its directivity via different coils.

The loudspeakers can be used not only to produce the rotating sound beam for imitation of the Tibetan singing bowls, but also for the production of other sounds, for example for a relaxation purpose a sound of sea waves.

The vibration element can be an excitation device, an ultra sound vibrator, a pancake motor device or any other vibration element known in the art. The control unit 7 can be for example a processor device executing a program. The sound device 3, the vibration element 5 and the control unit can also be integrated in a single device. The loudspeakers and the vibration element together produce the sound and the vibration very similar to the sound and the vibration produced by the Tibetan singing bowls. Any Tibetan singing bowl can be imitated by the single sound massage device. In order to achieve the imitation of a particular Tibetan singing bowl an adequate controlling of the loudspeakers and the vibration element by the control unit is required. In case that the control unit is constituted by the processor device executing the program, the program defines the particular Tibetan singing bowl that is imitated. Of course the program can also contain a profile, i.e. a sequence of one or more Tibetan singing bowls wherein also the duration of each of the sounds and vibrations is determined. The program could be also suitable that a user of the sound massage device can himself define the profile, i.e. Tibetan singing bowls to be imitated and the duration of the corresponding sounds and vibrations. So, the user should be able to select one of the existing profiles or to define a new profile. Such profiles can be also placed on the Internet after being created, so that different users can download, i.e. share, profiles with each other.

A second embodiment of the invention is shown in FIG. 2. The sound massage system 1 further comprises a bio sensor 11 for measuring a bio-parameter of an object 9, in particular a human or an animal, who is using the system. The control unit 7 controls the sound device 3 and the vibration element 5 based on the measured bio-parameter so that an optimal massaging is achieved. The biosensor can be a device for measuring the object's vital signs, for example heart rate, respiration rate, SPO2, temperature, skin resistance or any other vital sign.

Such sound massaging system possesses the ability to respond on the effects that it initiates on the object and to adapt itself in such way that the maximal object's satisfaction is achieved. With the original Tibetan singing bowls this is not possible, since the number of singing bowls, and accordingly the number of the possible sounds and vibrations, is limited.

The bio sensor can be either integrated in the sound massage system or as a separate unit which communicates the measured value of the bio-parameter to the control unit in wired or in wireless way. In case of wireless communication, it can be a Bluetooth, WiFi, Infrared or any other wireless communication known in the art.

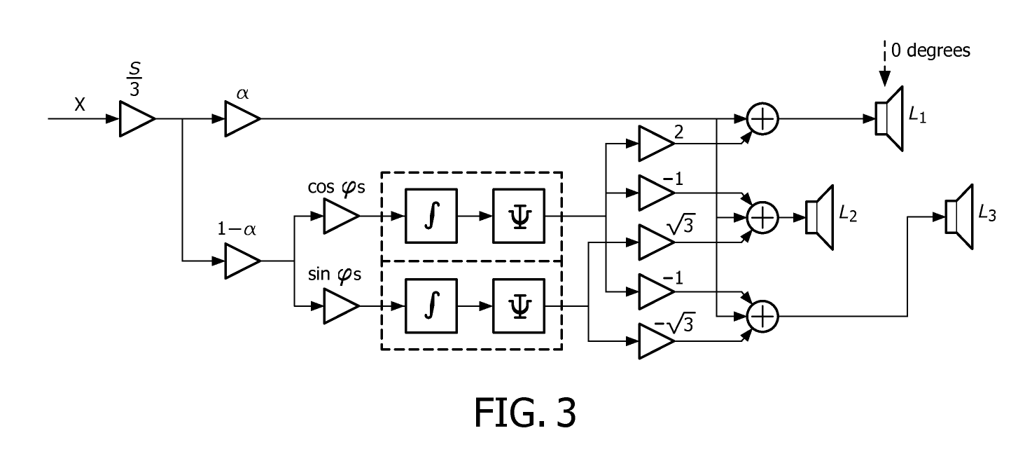

FIG. 3 schematically shows an electric circuit for production of a rotating sound beam by changing the angle versus time. According to the example shown in FIG. 3 the electric circuit comprises three loudspeakers L1;L2;L3 that are placed uniformly on a circle. The signal to be reproduced is given by x. Each loudspeaker is excited with a times the monopole component and 1−α times a steered dipole component parameterized with a steering parameter φₛ. This steered dipole is constructed as a linear combination of two orthogonal dipoles. The orthogonal dipoles are constructed by using several scale factors as shown in FIG. 3.

The weights values cos φₛ and sin φₛ require the value φₛ which is given by the following equation: φₛ=φₙ−2*arctan ((1−cos (φₙ)+sqrt(A))/4*sin (φₙ)), wherein A=(cos (φₙ)−1)²+16*sin² (φₙ) and wherein φₙ is the null-angle.

The computation of the values of a and S is given by the following equations:

α=cos (φₙ−φₛ)/(cos (φₙ−φₛ)−1)

S=1/(α+(1−α)*cos (φₛ))

The compensation factor ψ is given by ψ=c\r, where c is the speed of sound in air and r is the radius of the circular loudspeaker array. Furthermore, ∫ is a first order integrator with a low-pass character of 6 dB/octave.

A possibility to specify the preferred operating range of the circular array is to relate the maximum frequency f, to the wavelength λ, and the radius of the array r. It is proffered that the half of a wavelength is more than two times the radius, i.e. λ/2>2*r or r<λ/4. Since λ=c/f the proffered maximum frequency f<c/(4*r).

The sound unit can also comprise two loudspeakers as an array and control of the loudspeakers can be done by the control unit in such way that a notch, or null, in the polar pattern will occur. This can be done by having at a certain observation angle of the array such a phase shift and amplitude difference between the loudspeakers that a notch will be present. This notch can be changed in position in a rather slow fashion, e.g. a full rotation of the notch in one second. This will give such an effect to the radiation of the array that it can mimic the bowl, or will enable possibilities beyond the normal sound radiation of a normal bowl. A very simple embodiment is the dipole, i.e. two loudspeakers in anti-phase, by combining this dipole with another loudspeaker, or with one of the two loudspeakers in the dipole, other shapes can be made e.g. cardioids.

It is also noted that the sound massage device can be combined with e-textiles known in the art. The biosensor can be also included into such e-textiles.

While the invention has been illustrated and described in detail in the drawings and foregoing description, such illustration and description are to be considered illustrative or exemplary and not restrictive; the invention is not limited to the disclosed embodiments.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage. Any reference signs in the claims should not be construed as limiting the scope.

### LIST OF REFERENCE NUMERALS

1 a sound massage system

3 a sound device

5 a vibration element

7 a control unit

9 an object

11 a biosensor

1. A sound massage system (1) for imitating a sound and a vibration of a Tibetan singing bowl comprising:
a sound device (3) arranged for producing a rotating sound beam,
a vibration element (5) arranged for producing vibrations, wherein the vibration frequency is less than 300 Hertz,
a biosensor (11) for measuring a bio-parameter of an object (9), in particular a human or an animal, who is using the system (1)
a control unit (7) arranged for controlling the sound device (3) and the vibration element (5) based on the measured bio-parameter.

2. The system as claimed in claim 1, wherein the sound device (3) comprises at least one loudspeaker (3).

3. The system as claimed in claim 1, wherein the vibration element (5) comprises an excitation device, an ultra sound vibrator or pancake motor device.

4. The system as claimed in claim 1, wherein the control unit (7) comprises a processor device arranged for executing a control program.

5. (canceled)

6. The system as claimed in claim 1, wherein the measured bio-parameter is sent by the biosensor (11) to the control unit (7) wirelessly.

7. A relaxation system comprising the sound massage system (1) as claimed in claim 1.
